(19) United States
(12) Patent Application Publication
(10) Pub. No.: US 2002/0085534 A1
(43) Pub. Date: Jul. 4, 2002

(54) Device independent communication system

(76) Inventors: Donald A. Williams, The Woodlands, TX (US); Christopher L. Williams, The Woodlands, TX (US); Carlos L. Maynard, The Woodlands, TX (US); Javier H. Munoz, The Woodlands, TX (US)

Correspondence Address: TELECONOMICO USA INC., 26009 BUDDE ROAD, SUITES B-200/B-300, THE WOODLANDS, TX, 77380, US

(21) Appl. No.: 09/750,197

(22) Filed: Dec. 28, 2000

(51) Int. Cl. H04L 12/66

(52) U.S. Cl. 370/352; 370/401

(57) ABSTRACT

In one embodiment the invention comprises a method for transmitting a message over the Internet in which a communication transmitted from a first connection device in a medium of said first connection device is received on a server, and the communication is converted from said medium of said first connection device into a medium of a second connection device, said medium of said first connection device and said medium of said second connection device being different. The converted communication is then transmitted to said second connection device.

### BACKGROUND OF THE INVENTION

1. Field of the Invention

This invention is related to the general subject of Internet communications and in particular Internet communications between different connection platforms.

2. Description of Related Art

The Internet originated from U.S. Government funded research which made possible a national internetworked communication system. This work resulted in the development of a set of conventions (protocols) for interconnecting networks and routing information. These protocols are generally referred to as TCP/IP (Transmission Control Protocol Internet Protocol). The Internet basically comprises several large computer networks joined together over high speed data links.

A simplified diagram of the Internet is shown in FIG. 1. The Internet comprises Autonomous Systems (ASs), which may be operated by Internet Service Providers (ISPs). such as PDQ and America On Line (AOL). FIG. 1 shows three AS/ISPs designated by numerals 10, 12 and 14. The Autonomous Systems are linked together by communication links 11, 13 and 15, which may be fiber optic links. The Internet also includes Information Providers, such as various governmental agencies and universities. FIG. 1 shows three Information Providers, designated by numerals 16, 18 and 24. The Information Providers are shown linked to the Internet by communication links 20, 22 and 26, which may be fiber optic communication links.

Corporate Local Area Networks (LANs), such as those illustrated in 28 and 30, are connected through routers 32 and 34 and communication links 36 and 38. Laptop computers 40 and 42, representative of computers connected to the Internet via the public switched telephone network (PSTN), are shown connected to the AS/ISPs via dial up links 44 and 46.

The Information Providers collect and market information through their own servers. Internet Service Providers, which market the usage of their networks, transport the information from the Information Providers to the user who requests the information.

The Internet may be viewed as a series of routers connected together, and with computers connected to the routers. In the addressing scheme of the Internet an address comprises a set of four numbers separated by dots. An example would be 164.947.483.492. Each machine on the Internet has a unique address which constitutes one of these four number sets. The leftmost number in the address is the highest order number, and is generally referred to as the first number. Typically, the first two numbers will indicate a network or a location. When the packet bearing the destination address leaves the source router it compares the first two numbers with a matrix table to determine how many hops are the minimum to get to the destination. Each router has a data base table that finds the information automatically. The router then sends the packet to the next router determined from that table and the procedure is repeated. This continues at each router along the transmission path until the packet arrives at the destination computer. The next number field, number 483 in the example shown, identifies the destination router. The last number identifies the specific computer in the destination network. That network is connected to the last router in the transport path. In differentiating between two computers in the same destination network only the last number field changes. The separate packets that constitute a message may not travel the same path across the Internet, because of variations in the Internet traffic load. However the data packets all reach the same destination and are assembled in their original order in a connectionless fashion.

One of the more frequently used services available on the Internet is electronic mail, or e-mail. Initially, e-mail software only allowed a person using one computer to type a message and send it across the Internet to a person using another computer. However, current e-mail systems can be used to send a single message to many recipients, send a message that includes text, audio, video, or graphics, send a message to a user on a network outside the Internet, or send a message to which a computer program responds,

Computer communication always involves interaction between two programs called a client and a server. E-mail systems follow the client-server approach: two programs cooperate to transfer an e-mail message from the sender's computer to the recipient's mailbox (transfer requires two programs because an application running on one computer cannot store data directly in a mailbox on another computer's disk). When a user sends an e-mail message, a program on the sender's computer becomes a client. It contacts an email server program on the recipient's computer and transfers a copy of the message. The server stores the message in the recipient's mailbox. The interaction between a client and server is complex because at any time computers or the Internet connecting them can fail (e.g., someone can accidently turn off one of the computers). To ensure that e-mail will be delivered reliably, the client keeps a copy of the message during the transfer. After the server informs the client that the message has been received and stored on disk, the client may erase its copy.

To receive electronic mail, a user must have a mailbox, identified by a unique address, which resides on a computer which runs e-mail software, and a storage area. usually on a disk, that holds incoming e-mail messages until the user has time to read them. When a message arrives, e-mail software automatically stores it in the user's mailbox.

To send electronic mail across the Internet, an individual runs an e-mail application program on their local computer. The local application program operates similar to a word processor—it allows a user to compose and edit a message and to specify a recipient by giving a mailbox address. Once the user finishes entering the message and adds attachments, e-mail software sends it across the Internet to the recipients's mailbox.

When an incoming e-mail message arrives, system software is configured to inform the recipient by displaying text or a graphic symbol on the user's display or by other means. Once e-mail has arrived, a user can extract messages from the user's mailbox using an application program. The application allows a user to view each message. After viewing a message, a user can send a reply to whoever sent the message, leave the message in the mailbox so it can be viewed again, save a copy of the message in a file, or discard the message.

A computer cannot receive e-mail unless it has an e-mail server program running. On large computers, the system administrator arranges to start the server when the system first begins, and leaves the server running at all times. The server waits for an e-mail message to arrive, stores the message in the appropriate mailbox on disk, and then waits for the next message. However, a user who has a personal computer that is frequently powered down or disconnected from the Internet cannot receive e-mail while the computer is inactive. Therefore, most personal computers do not receive e-mail directly. Instead, a user arranges to have a mailbox on a large computer with a server that always remains ready to accept an e-mail message and store it in the user's mailbox. For example, a user can choose to place their mailbox on their company's main computer, even if they used a personal computer for most work. To read e-mail from a personal computer, a user must contact the main computer system and obtain a copy of their mailbox.

One or more companies have recently developed software for use on personal computers to permit two-way transfer of real-time voice information via an Internet data link between two personal computers. In one of the directions the sending computer converts voice signals from analog to digital format. The software facilitates data compression down to a rate compatible with modem communication via a POTS telephone line. The software also facilitates encapsulation of the digitized and compressed voice data into the TCP/IP protocol with appropriate addressing to permit communication via the Internet. At the receiving end, the computer and software reverse the process to recover the analog voice information for presentation to the other party. Such programs permit telephone—like communication between Internet users registered with Internet Phone Servers.

More recently instant messaging systems have been implemented by Internet and email service providers which allow a digital message transmitted over the Internet to appear on the display screen of one or more second users as soon as the message is transmitted to the second user's computer. In contrast to standard e-mail, which is a type of asychronic communication, instant messaging is a type of synchronic communication.

A need continues to exist, however, for further enhanced uses of the Internet to facilitate communications. In particular a need exists to merge synchronic and asychronic communications.

It should be noted that the description of the invention which follows should not be construed as limiting the invention to the examples and preferred embodiments shown and described. Those skilled in the art to which this invention pertains will be able to devise variations of this invention within the scope of the appended claims.

### SUMMARY OF THE INVENTION

In one embodiment the invention comprises a method for transmitting a message over the Internet in which a communication transmitted from a first connection device in a medium of said first connection device is received on a server, and the communication is converted from said medium of said first connection device into a medium of a second connection device, said medium of said first connection device and said medium of said second connection device being different. The converted communication is then transmitted to said second connection device.

### BRIEF DESCRIPTION OF THE DRAWINGS

FIG. 1 illustrates the background of the invention.

FIG. 2 is a diagram showing an embodiment of the invention.

FIG. 3 shows a specific implementation of the invention.

FIG. 4 shows another specific implementation of the invention.

FIG. 5 shows a form of data base useful in implementing the invention.

FIG. 6 shows a typical computer monitor display for utilizing the invention.

### DESCRIPTION OF PREFERRED EMBODIMENTS

In one embodiment, the invention comprises a system for enabling communication across the Internet between different kinds of connection devices, in which the communication may be originated in the natural communication medium of the originating device and received in the natural communication medium of the receiving device, which is different from the communication medium of the originating device. The connection devices may include computers, telephones, pagers, cellular telephones utilizing the small message system (SMS), PDA devices utilizing the WAP network and other devices. When the connection device is a computer, a natural communication medium may be text, graphics, voice or video. When the connection device is a telephone, the natural communication medium is normally voice. When the connection device is a pager, the natural communication medium may be a numeric message. When the connection device is a cellular telephone utilizing the small messaging system (SMS), the natural communication medium may be text. When the connection device is a PDA utilizing the WAP network, the natural communication medium may be a text message.

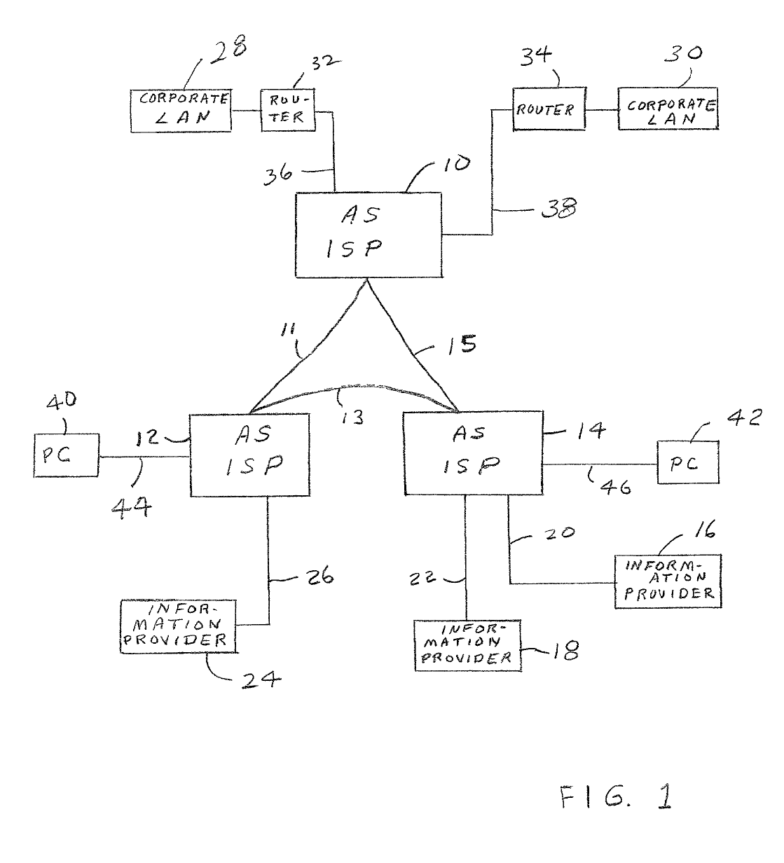

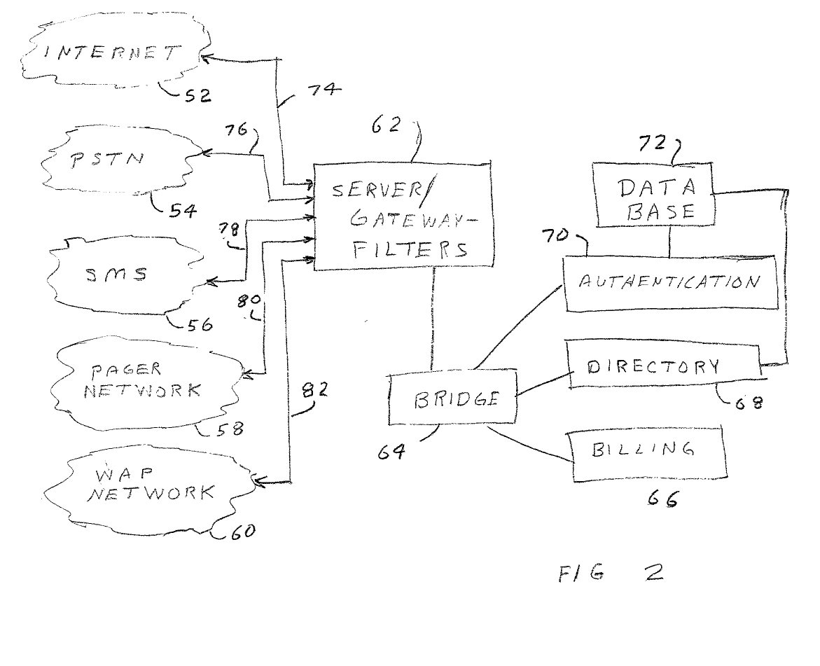

A diagram of an implementation of the invention is shown in FIG. 2. Messages generated from a connection device from either of the Internet 52, the Public Switched Telephone Network (PSTN) 54, the Small Message System (SMS) Network 56 utilized by certain cellular telephones, the pager Network 58, the WAP network 60 utilized by certain personal digital assistant (PDA) devices are routed to Server/Gateway-Filter System 62. Each of the communication channels 74, 76, 78, 80 and 82 are shown as bidirectional, so that a communication traveling from the Internet to the Server/Gateway-Filter System 62 may be routed to any of the PSTN, SMS, Pager or WAP networks; a communication traveling from the PSTN to the Server/Gateway-Filter System 62 may be routed to any of the Internet, SMS, Pager or WAP networks; a communication traveling from the SMS network to the Server Gateway-Filter System 62 may be routed to any of the Internet, PSTN, Pager or WAP networks; a communication traveling from the Pager network to the Server/Gateway-Filter System 62 may be routed to any of the Internet, PSTN, SMS or WAP networks; and a communication traveling from the WAP network to the Server/Gateway-Filter System 62 may be routed to any of the Internet, PSTN, Pager, SMS or WAP networks.

Each message transmitted to Server/Gateway-Filter System 62 will normally include the address or other identification of the connection device to which the user desires to transmit a message and may include validation information, such as the user identification number and password, to enable confirmation that the user is entitled to use the system. This information is transmitted to bridge, or connection point, 64. The bridge, or connection point, 64, which may be implemented in software, will then convey this information to authentication system 70, directory 68 and billing system 66.

The authentication system 70 will check the received information against data stored in data base 72, to confirm that the system user who initiated the message is authorized to use the service. In one implementation of the system the intended recipient of the communication would not need to be a subscriber to the communication system operating according to the present invention. In one implementation of the invention the directory system may look up, in directory 68, the number of the connection device the user desires to communicate with, which may have been identified by a “friendly name”. The billing system 66 will calculate charges on a time basis or transaction basis, according to methods well known to those of ordinary skill in the art.

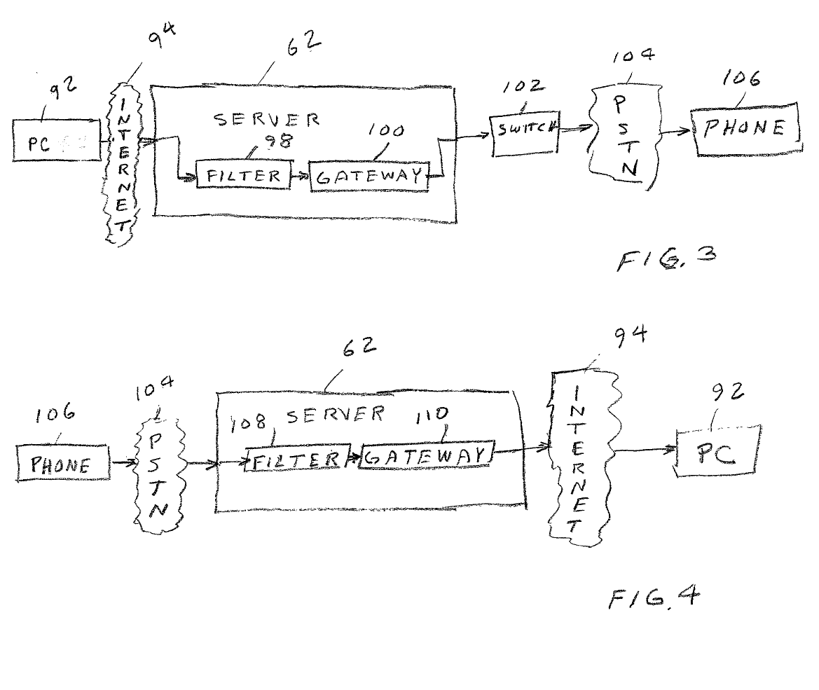

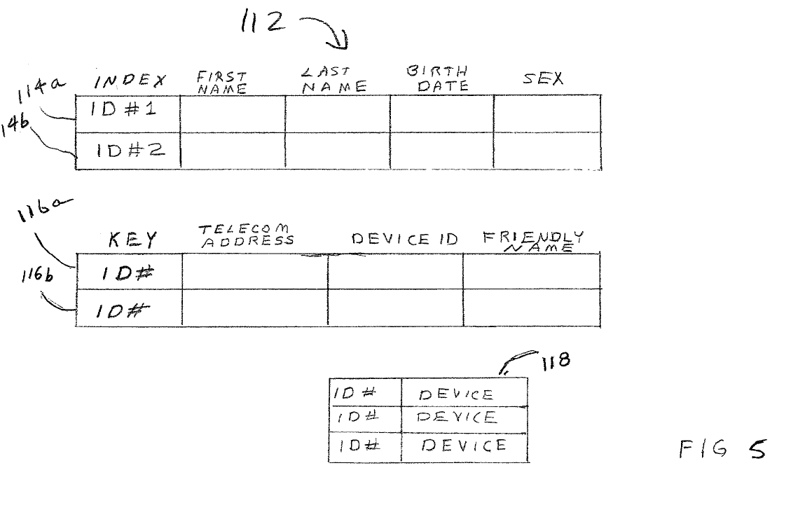

FIG. 3 shows an implementation of the present invention in more detail in which the communication path is from a computer to a telephone. Similarly, FIG. 4 shows an implementation of the present invention in more detail in which the communication path is from a telephone to a computer. FIG. 3 shows PC (personal computer) 92 on which a text message is generated for transmission to telephone 106, which receives the message as a voice message. The text message is transmitted from PC 92 to server/gateway-filter system 62. Although there may be a direct connection between PC 92 and the server gateway-filter system 62, typically the routing may be through one or more routers forming a part of the Internet system 94. Server/gateway-filter system 62 will determine from the address specified in the message that the message is intended for transmission to a telephone, and the signal will be connected to filter 98, which synthesizes a voice message from the text message and connects the synthesized voice message to gateway 100. The synthesized voice message is then transferred through switch 102, which may also reside on server 62, to the PSTN. The message is then conveyed through the PSTN to the telephone number specified by PC 92 in the message transmission. The switch 102 initially sends a message to the telephone to cause the telephone to ring. When the server 62 receives confirmation that the telephone has been answered, the server transmits the synthesized voice message to the telephone. The message may be stored temporarily on server/gateway-filter system 62 for later transmission if the telephone 106 is not answered on the first attempted transmission.

In a particular implementation of the invention, after the message is transmitted, a prompt will be transmitted to the receiving telephone to which the communication recipient may respond, e.g., by pressing one or more keys on the telephone keypad, or by voice response. The prompt will be transmitted by gateway 100, which will normally utilize the IVR (Interactive Voice Response) communication mode to provide a prompt in the form of a voice inquiry. The prompt may, for example, inquire of the recipient whether the recipient desires to forward the communication to another telephone or another Internet connection device, or whether the recipient desires to transmit a response to the person who transmitted the message.

If the recipient of the communication desires to respond to the person who sent the communication, normally the prompt will request the communication to speak the response message into the telephone in a normal manner. Switch 102 will then convert the message to a WAV (Wave Audio) file, a file format for voice, and the communication will be transmitted back to the computer that initiated the communication sequence in the manner described below with respect to a telephone to computer communication.

If the communication recipient desires to forward the communication, the response will typically be in the form of a number, which could be a telephone number or an e-mail address of the person the recipient of the communication desires to forward the communication to, which the communication recipient typically will enter by utilizing the telephone keypad, or by pronouncing the numbers into the telephone microphone.

Whereas FIG. 3 shows a configuration for generating a text message on a computer 92 for presentation as a voice message on telephone 106, FIG. 4 shows the converse, the generation of a voice message at telephone 106 for display as a text message on computer 92. Telephone 106 is utilized to input a voice message which is transmitted as a voice message on the PSTN 104. The voice message is transmitted from phone 106 over the PSTN to server/gateway-filter system 62. Server/gateway-filter system 62 will determine from the address dialed by the telephone that the message is intended for transmission to a computer, and the signal will be connected to filter 108, which converts the voice message to a text message by use of voice recognition software and connects the text message to gateway 110. The converted Internet message is then transmitted through Internet 94 to the PC 92 as a text e-mail message. The message may be stored temporarily on server/gateway-filter system 62 until the user of computer 92 checks the user's e-mail. It is understood that the telephone user might also specify the message to be delivered as an Instant Message, or as both an e-mail and an Instant Message.

When utilizing the invention described herein, communications from one platform (e.g., a personal computer) to a second kind of platform (e.g., a telephone) will appear to be largely “seamless”, with the communication flow having little interruption as a result of crossing from the network in which one of the platforms is operating to the network in which the other of the platforms is operating. Although embodiments of the invention are described in more detail in the context of communications between computers and telephones, it is understood that for communications between other connection devices contemplated by the present invention, a server/gateway-filter system will convert the communication from the medium and protocol of the device which initiates the communication into the medium and the protocol of the device to which the communication is addressed.

Regardless of the connection device which initiates the communication, typically, the first step in establishing the communication will be to log onto the system and enter an ID and a password, which is checked against a data base.

In a particular implementation of the invention a standard V-Card is utilized for creating a central directory system data base, which may utilize an XML (extensible micro language) structure. In methods known to the prior art of utilizing a V-Card for creating a data base, a series of rows and columns are utilized in which information related to a subscriber (such as name, birthday, sex, address, home phone number, work phone number, e-mail address) is all entered into data slots in one row. In accordance with an aspect of the present invention, an XML structure is utilized to create a central directory system data base 112, outlined in FIG. 5, in which static information (e.g., the persons name, birth date and sex) is stored in a first row, such as rows 114a and 114b and information which may vary, or which may need to be added to the data base (such as telephone numbers and e-mail addresses) is included in one or more additional rows, such as rows 116a and 116b shown in FIG. 5. The primary row of data for a subscriber is identified by an index identifier, and subsequent rows are identified by keys which reference one row to another. Look-up table 118 then identifies the type of device from the device ID number included in the data tables. The quantity of communication information for each subscriber can then expand as needed. For example, each row identified by a key which references the primary row might include a telecommunication address, a communication device ID number and a friendly name for the device, which may be a common reference term such as “home phone” (or “work phone”). The economics of this aspect of the invention relates to the fact that it is more economical to add additional rows to the data base when the amount of information that needs to be stored for a specific individual expands, than to add additional columns. If the data base were to include information regarding ten million subscribers, for example, to add an additional column to expand the data holding capacity for an individual, an additional row would need to added for the entire data base of ten million people. It can be appreciated that adding an additional row of data for a specific individual will be more economical than adding an additional column for a very large number of people.

The software which operates a service in accordance with the present invention will typically resides on a server, such as the server/gateway-filter 62 of FIG. 2. In order to utilize the invention from a computer, appropriate application program computer code will normally need to be installed on the computer, which will typically be made available over the Internet to a subscriber to the service. Those of ordinary skill in the art will understand how to write such computer code based on the description of the invention herein, and the code will not be discussed in detail herein.

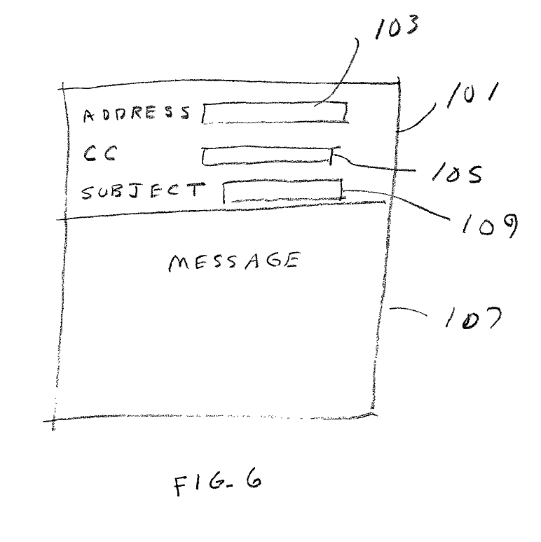

To enable a computer user to transmit a message in accordance with the present invention, the computer display monitor, typically, will display a format 101 which indicates to the user the locations for inserting the information needed to transmit the message. FIG. 6 shown such a display, which includes location 103 for inserting the intended recipient's address, location 105 for inserting any additional addresses the user desires to communication to be sent to, and location 107 for insertion of the message. The display may also include a location 109 for including a subject description for the communication.

In one implementation a service provided in accordance with the invention described herein may be provided as a part of a paid subscription service. It is contemplated that a service utilizing the present invention may also be offered as an enhancement to more standard e-mail services, Internet services or telephone services. Services utilizing the invention described herein may also be provided to a user without cost, through a service supported by advertising.

It will be appreciated that various modifications, alternatives, variations, and changes may be made without departing from the scope of the invention as defined in the appended claims. It is intended to cover by the appended claims all such modifications involved within the scope of the claims.

We claim:

1. A method for transmitting a message over the Internet comprising:
receiving on a server a communication transmitted from a first connection device in a communication medium of said first connection device;
converting said communication from said medium of said first connection device into a communication medium of a second connection device;
transmitting said converted communication to said second connection device; and
wherein said communication medium of said first connection device and said communication medium of said second connection device are different.

2. The method of claim 1 wherein the medium of said first connection device is text and the medium of said second connection device is voice.

3. The method of claim 1 wherein the medium of said first connection device is voice and the medium of said second connection device is text.

4. The method of claim 1 wherein said first connection device is a computer and said second connection device is a telephone.

5. The method of claim 1 wherein said first connection device is a telephone and said second connection device is a computer.

6. The method of claim 1 wherein said first connection device is a computer connected to the Internet and the communication medium of said computer is text and wherein said second connection device is a telephone connected to the public switched telephone network and the communication medium of said telephone is voice.

7. The method of claim 1 wherein said first connection device is a telephone connected to the public switched telephone network and the communication medium of said telephone is voice and wherein said second connection device is a computer connected to the Internet and the communication medium of said computer is text.

8. The method of claim 1 wherein said first connection device is a computer and said second connection device is a pager.

9. The method of claim 1 wherein said first connection device is a computer and said second connection device is personal digital assistant.

10. The method of claim 1 wherein said first connection device is computer and said second connection device is cellular telephone operating the small messaging system.

11. The method of claim 1 wherein said first connection device is telephone and said second connection device is a pager.

12. The method of claim 1 wherein said first connection device is a telephone and said second connection device is a personal digital assistant.

13. The method of claim 1 wherein said first connection device is a telephone and said second connection device is a cellular telephone operating a small messaging system

14. The method of claim 1 wherein said first connection device is a personal digital assistant and second connection device is a computer.

15. The method of claim 1 wherein said first connection device is a personal digital assistant and said second connection device is a telephone.

16. The method of claim 1 wherein said first connection device is a cellular telephone and second connection device is a computer.

17. The method of claim 1 wherein said first connection device is a cellular telephone and said second connection device is a telephone.

18. A method for transmitting a message from a telephone to a computer over the Internet, comprising:
establishing communication over the public switched telephone network from said telephone to a server on which voice recognition software resides for converting a voice message to text;
utilizing said voice recognition software to convert a voice message spoken into said telephone into a text message; and
connecting said text message to the Internet through a gateway which adds TCP/IP protocol for transmitting said text message across the Internet to said computer as a text message.

19. A method of transmitting a message from a computer to a telephone over the Internet, comprising:
establishing communication over the Internet between a computer and a server on which software resides for synthesizing a voice message from said text message:
utilizing said software to convert said text message to a voice message; and
connecting said voice message to the public switched telephone network for transmitting said voice message over the public switched telephone network to said telephone.

20. A process for transmitting a message from a first connection device to a second connection device over the Internet, comprising:
establishing communication from said first connection device to a server on which software resides for converting said message from a communication medium of said first connection device to a communication medium of said second connection device;
utilizing said software to convert said message from said first communication medium to said second communication medium; and
connecting said converted message through a gateway to a network on which said second connection device is connected to transmit said converted message to said second connection device.

21. The process of claim 20 wherein software for controlling said process resides on said server, said method further comprising:
checking validation information included in said message from said first connection device against a data base to verify that said message was generated by a user authorized to use said process.

22. The process of claim 21 wherein said data base comprises a storage structure in which a plurality of rows of data may be utilized to store information about a user, and a first row is identified by an index identifier and subsequent rows of information regarding said user are identified by a key referring to said first row of data.

23. Apparatus for transmitting a message over the Internet comprising:
a server for receiving a communication transmitted from a first connection device in a communication medium of said first connection device;
means residing on said server for converting said communication from said medium of said first connection device into a communication medium of a second connection device;
means for transmitting said converted communication to said second connection device; and
wherein said communication medium of said first connection device and said communication medium of said second connection device are different.

24. The apparatus of claim 23 wherein the medium of said first connection device is text and the medium of said second connection device is voice.

25. The apparatus of claim 23 wherein the medium of said first connection device is voice and the medium of said second connection device is text.

26. The apparatus of claim 23 wherein said first connection device is a computer and said second connection device is a telephone.

27. The apparatus of claim 23 wherein said first connection device is a telephone and said second connection device is a computer.

28. The apparatus of claim 23 wherein said first connection device is a personal digital assistant and said second connection device is a telephone.

29. The apparatus of claim 23 wherein said first connection device is a cellular telephone and second connection device is a computer.

30. The apparatus of claim 23 wherein said first connection device is a cellular telephone and said second connection device is a telephone.

31. The apparatus of claim 23 wherein said first connection device is a computer connected to the Internet and the communication medium of said computer is text and wherein said second connection device is a telephone connected to the public switched telephone network and the communication medium of said telephone is voice.

32. The apparatus of claim 23 wherein said first connection device is a telephone connected to the public switched telephone network and the communication medium of said telephone is voice and wherein said second connection device is a computer connected to the Internet and the communication medium of said computer is text.

33. The apparatus of claim 23 wherein said first connection device is a computer and said second connection device is a pager.

34. The apparatus of claim 23 wherein said first connection device is a computer and said second connection device is personal digital assistant.

35. The apparatus of claim 23 wherein said first connection device is computer and said second connection device is cellular telephone operating the small messaging system.

36. The apparatus of claim 23 wherein said first connection device is telephone and said second connection device is a pager.

37. The apparatus of claim 23 wherein said first connection device is a telephone and said second connection device is a personal digital assistant.

38. The apparatus of claim 23 wherein said first connection device is a telephone and said second connection device is a cellular telephone operating a small messaging system

39. The apparatus of claim 23 wherein said first connection device is a personal digital assistant and second connection device is a computer.

40. Apparatus for transmitting a message from a first connection device to a second connection device over the Internet, comprising:
a server on which software resides for converting said message from a communication medium of said first connection device to a communication medium of said second connection device;
means for establishing communication to said server from said first connection device; and
a gateway for connecting a message converted by said software to a network on which said second connection device is connected to transmit said converted message to said second connection device.

41. The apparatus of claim 40 further comprising:
a data base having a storage structure in which a plurality of rows of data are utilized to store information about a user, and a first row is identified by an index identifier and subsequent rows of information regarding said user are identified by a key referring to said first row of data; and
means for checking validation information included in said message from said first connection device against said data base to verify that said message was generated by a user authorized to use said apparatus.
